(19) United States
(12) Patent Application Publication
(10) Pub. No.: US 2011/0307719 A1
(43) Pub. Date: Dec. 15, 2011

(54) SYSTEM AND METHOD FOR CONNECTING POWER-SAVING LOCAL AREA NETWORK COMMUNICATION LINK

(75) Inventor: Seung Hyun YOON, Daejeon (KR)

(73) Assignee: Electronics and Telecommunications Research Institute, Daejeon (KR)

(21) Appl. No.: 12/942,657

(22) Filed: Nov. 9, 2010

(30) Foreign Application Priority Data
Jun. 11, 2010 (KR) 10-2010-0055175

(51) Int. Cl. G06F 1/32

(52) U.S. Cl. 713/320

(57) ABSTRACT

Provided is a power-saving local area network communication link connection system and method that may automatically switch a communication link between a computer terminal and an Ethernet switch using an Ethernet communication and thus, an Ethernet switch may be prevented from being unnecessarily used. The power-saving local area network communication link connection system may include a monitoring unit to obtain utilization information from each of the plurality of Ethernet switches, a command generating unit to generate a control command based on the utilization information, and a mode switching unit to control, based on the control command, a patch switch to be connected to each of the plurality of Ethernet switches, and to switch a mode of each of the plurality of Ethernet switches.

### CROSS-REFERENCE TO RELATED APPLICATION

This application claims the benefit of Korean Patent Application No. 10-2010-0055175, filed on Jun. 11, 2010, in the Korean Intellectual Property Office, the disclosure of which is incorporated herein by reference.

### BACKGROUND

1. Field of the Invention

The present invention relates to a power-saving local area network communication link connection system and method that may automatically switch a communication link between an Ethernet switch and a computer terminal that uses an Ethernet communication and thus, may prevent an Ethernet switch from being unnecessarily used.

2. Description of the Related Art

FIG. 1 illustrates a network of a conventional local area network communication link connection system.

Referring to FIG. 1, in a local network or a private network environment, a plurality of Ethernet switches are established in an operating room of each floor, and a communication equipment that connects communication ports of the plurality of Ethernet switches to communication ports placed in a location where computer terminals are located and thus, Internet communication may be provided to each computer terminal, for example, a PC, a server, a VoIP terminal, a network printer, and the like. Depending on the local network environment, a patch panel may be used or a communication port of an Ethernet switch may be directly connected.

The computer terminal may be connected to the communication ports via an unshielded twisted pair (UTP) cable to perform Ethernet communication, and the computer terminal may receive an Internet Protocol (IP) address for IP communication to use the Internet, the IP address being automatically or manually assigned.

The same number of communication ports of the Ethernet switches as a number of the communication ports in each floor or each building may be required to configure the communication equipment. Therefore, a plurality of access Ethernet switches, namely, layer 2 (L2) switches, may be established and managed in the operating room.

Currently, all the Ethernet switches in the operating room may be continuously operated uninterrupted regardless of whether the computer terminal is connected to a communication port and whether the communication terminal is operating. Accordingly, a heating, ventilating, and air conditioning (HVAC) system, and the like may also be continuously operated due to operated uninterrupted by the plurality of Ethernet switch equipments.

As long as a single port is connected, the Ethernet switch may not stop operating. Therefore, even when a relatively large number of ports are not connected to the computer terminal or are not in an operational state, power may be continuously consumed to continue operations.

Therefore, the conventional local area network communication link connection system may unnecessarily operate Ethernet switches and may also operate related devices and thus, may have a problem that power is continuously and unnecessarily consumed.

### SUMMARY

An aspect of the present invention provides a power-saving local area network communication link connection system and method that may enable only a computer terminal that is operated to use a network to be connected to an Ethernet switch and thus, may not unnecessarily use an Ethernet switch and may prevent unnecessary power consumption.

Another aspect of the present invention also provides a power-saving local area network communication link connection system and method that may intensively connect a computer terminal being used to a single Ethernet switch during the night where a utilization is generally low, and may switch remaining Ethernet switches to an idle mode to reduce power consumption.

According to an aspect of the present invention, there is provided a power-saving local area network communication link connection system, the system including a patch switch being connected to a plurality of Ethernet switches, a controller to control the patch switch and the plurality of Ethernet switches, and the controller may include a monitoring unit to monitor the plurality of Ethernet switches to obtain utilization information from each of the plurality of Ethernet switches, a command generating unit to generate a control command based on the utilization information, and a mode switching unit to control the patch switch based on the control command, and to switch a mode of each of the plurality of Ethernet switches.

According to an aspect of the present invention, there is provided a power-saving local area network communication link connection method, the method including monitoring a plurality of Ethernet switches in a power-saving local area network communication link connection system and obtaining utilization information from each of the plurality of Ethernet switches, generating a control command based on the utilization information in the power-saving local area network communication link connection system, controlling a patch switch based on the control command in the power-saving local area network communication link connection system, and switching a mode of each of the Ethernet switches in the power-saving local area network communication link connection system.

### Effect

According to embodiments, only a computer terminal that is operated to use a network may be connected to an Ethernet switch and thus, an Ethernet switch may not be unnecessarily used and unnecessary power consumption may be prevented.

According to embodiments, a computer terminal being used may be intensively connected to a single Ethernet switch during the night where a utilization is generally low, and remaining Ethernet switches may be switched to an idle mode to reduce power consumption.

Additional aspects, features, and/or advantages of the invention will be set forth in part in the description which follows and, in part, will be apparent from the description, or may be learned by practice of the invention.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating a network of a conventional local area network communication link connection system;

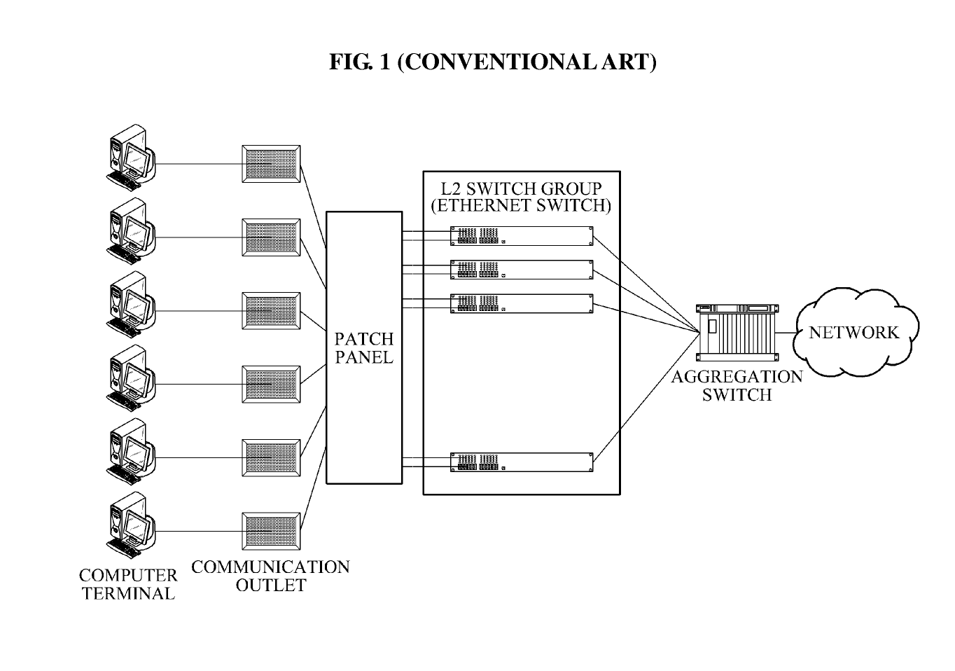

FIG. 2 is a diagram illustrating an internal configuration of a power-saving local area network communication link connection system according to an embodiment of the present invention;

FIG. 3 is a diagram illustrating an internal configuration of a patch switch according to an embodiment of the present invention; and

FIG. 4 is a flowchart illustrating a power-saving local area network communication link connection method.

### DETAILED DESCRIPTION

Reference will now be made in detail to embodiments of the present invention, examples of which are illustrated in the accompanying drawings, wherein like reference numerals refer to the like elements throughout. Embodiments are described below to explain the present invention by referring to the figures.

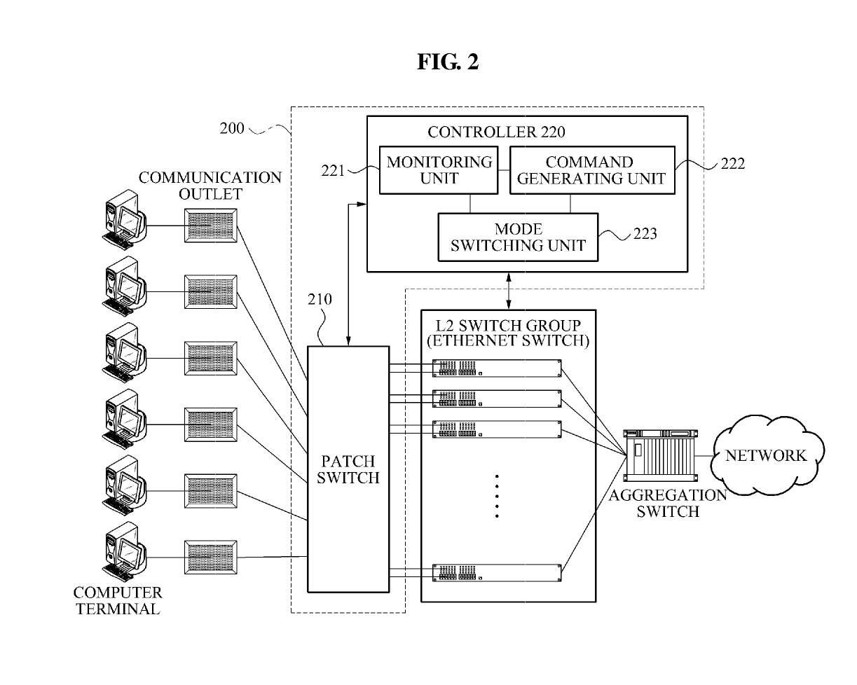

FIG. 2 illustrates an internal configuration of a power-saving local area network communication link connection system 200 according to an embodiment of the present invention

Referring to FIG. 2, the power-saving local area network communication link connection system 200 may include a patch switch 210 that may be connected to plurality of Ethernet switches and a controller 220 that may control the plurality of Ethernet switches.

The patch switch 210 may be arranged between the plurality of Ethernet switches and computer terminals, and may control a predetermined signal.

The controller 220 may include a monitoring unit 221, a command generating unit 222, and a mode switching unit, and may assign a control command to the patch switch and an Ethernet switch.

The controller 220 may control and manage a connection state of the patch switch 210, may monitor a communication port utilization and the like in layer 2 (L2) switches, namely the plurality of Ethernet switches, may determine whether to expand or minimize a number of Ethernet switches to be operated, and may control an operation of the plurality of Ethernet switches.

The monitoring unit 221 of the controller 220 may obtain, from each of the plurality of Ethernet switches, utilization information with respect to a corresponding Ethernet switch.

The monitoring unit 221 may monitor the plurality of Ethernet switches, and may obtain a communication port utilization in each Ethernet switch or may obtain information with respect to data traffic utilization in each Ethernet switch. For example, the monitoring unit 221 may generate the utilization information with respect to each Ethernet switch or the utilization information for each communication port of each Ethernet switch, based on a number of computer terminals being connected to each Ethernet switch and being in operation.

The command generating unit 222 of the controller 220 may generate a control command associated with the patch switch 210 and the plurality of Ethernet switches, based on the obtained utilization information. The command generating unit 222 may generate the control command based on the utilization information associated with at least one of a time, and a place.

For example, the command generating unit 222 may generate the control command associated with minimizing an operation with respect to a first switch that may not satisfy a predetermined standard, namely, the first switch of which utilization information is less than or equal to the predetermined standard. For example, the utilization information may not satisfy the predetermined standard during quitting time of work where an amount of operation of the computer terminals may rapidly decrease. In this example, the command generating unit 222 may generate a control command to minimize associated with minimizing the operation to prevent a switch from being unnecessarily operated and thus, unnecessary power consumption may be avoided.

When the utilization information satisfies the predetermined standard, the command generating unit 222 may generate a control command associated with expanding the operation with respect to the first Ethernet switch that is set to an idle mode. For example, the utilization information may increase and satisfy the predetermined standard during starting time of work where an amount of the operation of the computer terminals may rapidly increase. In this example, the command generating unit 222 may generate the control command associated with expanding the operation and thus, may prepare to respond to a request from each computer terminal for connection with respect to a communication link. For another example, the command generating unit 222 may generate the control command associated with expanding the operation during a time that is set by a manager, for example, ten minutes before the starting time of work, regardless of the utilization information.

For another example, the control command may be generated additionally based on a location where the computer terminal exists, for example, a place where a worker stays and works, and based on an environment of the computer terminal, for example, a power supply condition, and the like.

The mode switching unit 223 may control the patch switch 210 connected to each of the plurality of Ethernet switches based on the control command and may switch a mode of each of the plurality of Ethernet switches.

For example, when the command generating unit 222 generates the control command associated with minimizing the operation, the mode switching unit 223 may control the patch switch 210 based on the control command to switch the first Ethernet switch to an idle mode. For example, the mode switching unit 223 may drive an idle mode function of the first Ethernet switch or may shut down a power supplied to the first Ethernet switch using a multi-outlet that may control power for each outlet and thus, the first Ethernet switch may be switched from a normal mode to the idle mode. The mode switching unit 223 may register, in the patch switch 210, the first Ethernet switch switched to the idle mode as being in a non-operational state to prevent a connection of the communication link with the computer terminal from being established.

When a computer terminal connected to the first Ethernet switch via the communication link is being used, the mode switching unit 223 may control the patch switch 210 to release the connection of the communication link, and may connect the computer terminal to a second Ethernet switch, the second Ethernet switch satisfying a predetermined standard and being set to a normal mode.

The mode switching unit 223 may determine to switch an Ethernet switch to which a relatively small number of computer terminals are connected and operated, into an idle mode, such as a sleep mode or a power-saving mode. When a computer terminal connected to the corresponding Ethernet switch exists, the mode switching unit 223 may control the patch switch 210 to connect the computer terminal to a communication port of another Ethernet switch being operated as a normal mode. To prevent a newly operated computer terminal from being connected to the Ethernet switch to be switched to the idle mode, the mode switching unit 223 may register, in the patch switch 210, the Ethernet switch to be switched to the idle mode as being in a non-operational state or as an idle mode. Therefore, the newly operated computer terminal may be prevented from being connected to the Ethernet switch and the Ethernet switch may be switched to the idle mode.

For another example, when the command generating unit 222 generates the control command associated with expanding the operation, the mode switching unit 223 may switch an Ethernet switch being in the idle mode to a normal mode based on the control command. For example, the mode switching unit 223 may switch the first Ethernet switch being in the idle mode into the normal mode or may supply power to the first Ethernet switch using the multi-outlet that may control power for each outlet and thus, the first Ethernet switch may be switched from the idle mode to the normal mode. The mode switching unit 223 may register, in the patch switch 210, the first Ethernet switched into the normal mode as being in an operational state to enable the first Ethernet switch to establish a communication link with a new computer terminal.

When a utilization determined by checking a utilization of an Ethernet switch is higher than a predetermined standard, or when a lack of communication ports of the Ethernet switch is expected because a previously unused computer terminal has begun being operated, the command generating unit 222 may determine to expand the operation. When the expansion of the operation is determined, the mode switching unit 223 may switch an Ethernet switch being in an idle mode into a normal mode, and may register, in the patch switch 210, the Ethernet switch being switched into the normal mode as being in an operational state and thus, the newly operated computer terminal may be connected to the newly operated Ethernet switch.

The patch switch 210 may connect computer terminals to Ethernet switches that may be registered as being in the operational state among the plurality of Ethernet switches.

The mode switching unit 223 may control each Ethernet switch among the plurality of Ethernet switches based on an operational mode with respect to the plurality of Ethernet switches, and based on whether an air conditioning system, a heating, ventilating, and air conditioning (HVAC) system is operated, an operation rate, and the like and thus, a power consumption in an operating room may be reduced.

According to embodiments, an unnecessary operation of network equipment is minimized based on whether a computer terminal is connected and operated and thus, power consumption of the communication equipment may be reduced.

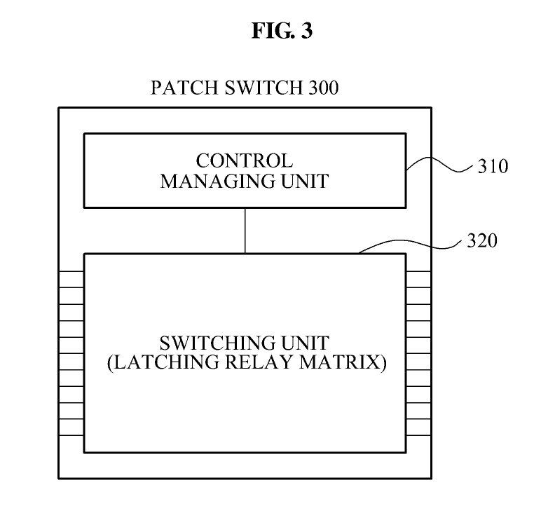

The patch switch 210 may switch a physical link between a computer terminal and an Ethernet switch. When the computer terminal attempts a connection with an Ethernet switch, the patch switch 210 may sense the attempt and may enable the computer terminal to be connected to a communication port of an appropriate Ethernet switch (L2 switch). As illustrated in FIG. 2, all communication ports of computer terminals may not be directly connected to Ethernet switches, and may be connected to the Ethernet switches via the patch switch 210. Hereinafter, the patch switch 210 may be described with reference to FIG. 3.

FIG. 3 illustrates an internal configuration of a patch switch 300 according to an embodiment of the present invention.

Referring to FIG. 3, the patch switch 300 may include a control managing unit 310 and a switching unit 320.

The control managing unit 310 may continuously interoperate with the power-saving local area network communication link connection system 200 and thus, may be configured by a low-power device. The switching unit 320 may be configured by a matrix of a latching type relay. In a case of a latching relay, power may be consumed when a connection is switched and a relatively small amount of power may be expended for maintaining a connection state and thus, the switching unit 320 may operate without power most times where the communication is not switched. In the same manner, the patch switch 300 may operate with a low power or may operate without power and thus, unnecessary power consumption may be prevented from being used.

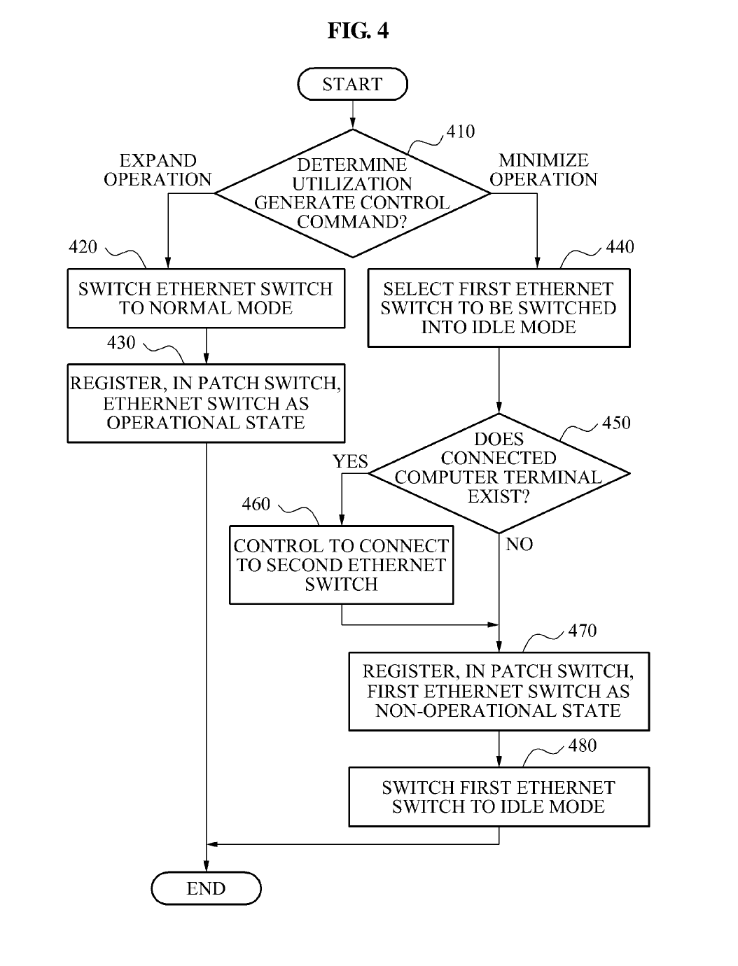

FIG. 4 illustrates a power-saving local area network communication link connecting method.

The power-saving local area network communication link connection method may be embodied by the power-saving local area network communication link connection system 200. The power-saving local area network communication link connection method may be described with reference to FIGS. 2 and 4.

In operation 410, the power-saving local area network communication link connection system 200 determines a utilization with respect to a plurality of Ethernet switches.

When the determination in operation 410 determines to expand an operation, the power-saving local area network communication link connection system 200 generates a control command associated with expanding the operation, and controls the patch switch 210 to switch an Ethernet switch being in an idle mode to a normal mode in operation 420, based on the control command.

In operation 430, the power-saving local area network communication link connection system 200 registers, in the patch switch 210, the Ethernet switch switched to the normal mode as being in an operational state, to enable the Ethernet switch to be connected to a computer terminal.

Conversely, when the determination in operation 410 determines to minimize the operation, the power-saving local area network communication link connection system 200 selects a first Ethernet switch being an Ethernet switch of which utilization information fails to satisfy a predetermined standard in operation 440. Subsequently, the power-saving local area network communication link connection system 200 may generate a control command associated with minimizing the operation to switch the first Ethernet switch to an idle mode.

In operation 450, the power-saving local area network communication link connection system 200 determines whether a computer terminal connected to the first Ethernet switch exists.

When the determination in operation 450 determines that the computer terminal connected to the first Ethernet switch exists, the power-saving local area network communication link connection system 200 proceeds with operation 460. In operation 460, the power-saving local area network communication link connection system 200 controls the patch switch 210 to connect the computer terminal to a second Ethernet switch, the second Ethernet switch satisfying a predetermined standard and being set to a normal mode.

When the determination in operation 450 determines that the computer terminal connected to the first Ethernet switch does not exist, or when the computer terminal is connected to the second Ethernet set to the normal mode, the power-saving local area network communication link connection system 200 may proceed with operation 470. In operation 470, the power-saving local area network communication link connection system 200 may register, in the patch switch 210, the first Ethernet switch as being in a non-operational state to prevent a connection of communication link with the computer terminal from being established.

In operation 480, the power-saving local area network communication link connection system 200 switches the first Ethernet switch to an idle mode based on the control command.

According to embodiments, an unnecessary operation of network equipment is minimized based on a computer terminal being operated and thus, a power consumption of the communication equipment may be reduced.

The method according to the above-described embodiments of the present invention may be recorded in non-transitory computer readable media including program instructions to implement various operations embodied by a computer. The media may also include, alone or in combination with the program instructions, data files, data structures, and the like. Examples of non-transitory computer readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A system for connecting a power-saving local area network communication link, the system comprising:
a patch switch being connected to a plurality of Ethernet switches; and
a controller to control the patch switch and the plurality of Ethernet switches,
wherein the controller comprises:
a monitoring unit to monitor the plurality of Ethernet switches to obtain utilization information from each of the plurality of Ethernet switches;
a command generating unit to generate a control command based on the utilization information; and
a mode switching unit to control the patch switch based on the control command, and to switch a mode of each of the plurality of Ethernet switches.

2. The system of claim 1, wherein the monitoring unit obtains, from each of the Ethernet switches, information associated with a communication port utilization or information associated with a data traffic utilization, as the utilization information.

3. The system of claim 1, wherein:
the command generating unit performs generating a control command associated with minimizing an operation with respect to a first Ethernet switch of which the utilization information fails to satisfy a predetermined standard; and
the command generating unit performs controlling the mode switching unit to switch the first Ethernet switch to an idle mode.

4. The system of claim 3, wherein, when a computer terminal that is connected to the first Ethernet switch via a communication link is being used, the patch switch controls the mode switching unit to release the connection of the communication link and to connect the computer terminal to a second Ethernet switch, the second Ethernet switch satisfying the predetermined standard.

5. The system of claim 3, wherein the mode switching unit registers, in the patch switch, the first Ethernet switch that is switched to the idle mode as being in a non-operational state to prevent a connection of the communication link from becoming established.

6. The system of claim 1, wherein:
the command generating unit performs generating a control command associated with expanding an operation with respect to a first Ethernet switch being set to an idle mode when the utilization information satisfies a predetermined standard; and
the command generating unit performs controlling the mode switching unit to switch the first Ethernet switch to a normal mode based on the control command.

7. The system of claim 6, wherein the mode switching unit registers, in the patch switch, the first Ethernet switch that is switched to the normal mode as being in an operational state to enable a connection of the communication link to be established.

8. The system of claim 1, wherein, when a connection request to request a connection of the communication link to be established is generated from a computer terminal, the patch switch controls the mode switching unit to connect the computer terminal to one of Ethernet switches that are registered as being in an operational state.

9. The system of claim 1, wherein the mode switching unit controls an idle mode function included in each Ethernet switch, or controls supplying power to each Ethernet switch using a multi outlet.

10. A method of connecting a power-saving local area network communication link, the method comprising:
monitoring a plurality of Ethernet switches in a power-saving local area network communication link connection system and obtaining utilization information from each of the plurality of Ethernet switches;
generating a control command based on the utilization information in the power-saving local area network communication link connection system;
controlling a patch switch based on the control command in the power-saving local area network communication link connection system; and
switching a mode of each of the Ethernet switches in the power-saving local area network communication link connection system.

11. The method of claim 10, wherein:
the generating comprises generating of a control command associated with minimizing an operation with respect to a first Ethernet switch of which a utilization fails to satisfy a predetermined standard; and
the switching comprises switching of the first Ethernet switch to an idle mode based on the control command.

12. The method of claim 11, wherein, when a computer terminal that is connected to the first Ethernet switch via a communication link is being used, the switching further comprises:
releasing the communication link and connecting the computer terminal to a second Ethernet switch satisfying the predetermined standard.

13. The method of claim 11, wherein the switching further comprises:
registering, in the patch switch, the first Ethernet switch that is switched to the idle mode as being in an non-operational state to prevent a connection of the communication link from becoming established.

14. The method of claim 10, wherein:
the generating comprises generating of a control command associated with expanding an operation with respect to the first Ethernet switch that is set to an idle mode when the utilization information satisfies the predetermined standard; and
the switching comprises switching of the first Ethernet switch to a normal mode based on the control command.

15. The method of claim 14, wherein the switching further comprises:
registering, in the patch switch, the first Ethernet switch switched into the normal mode as being in an operational state to enable a connection of the communication link to be established.
